(19) United States
(12) Patent Application Publication
(10) Pub. No.: US 2010/0285277 A1
(43) Pub. Date: Nov. 11, 2010

(54) METHOD FOR PROTECTING A GLASS EDGE USING A MACHINABLE METAL ARMOR

(76) Inventors: Victoria Ann Edwards, Horseheads, NY (US); Daniel Warren Hawtof, Corning, NY (US); Paul John Shustack, Elmira, NY (US)

Correspondence Address: CORNING INCORPORATED, SP-TI-3-1, CORNING, NY, 14831, US

(21) Appl. No.: 12/533,056

(22) Filed: Jul. 31, 2009

Related U.S. Application Data
(60) Provisional application No. 61/177,088, filed on May 11, 2009.

(51) Int. Cl. B32B 3/02; B32B 37/14; B32B 37/12

(52) U.S. Cl. 428/157; 156/60; 156/330; 156/331.7; 156/327

(57) ABSTRACT

The invention is directed to glass articles having improved resistance to edge fracture resulting from armoring the edges using metallic material adhesively bonded to the edges of the glass article. In one embodiment the metallic edge material is machinable to enable final finish of the part to specification tolerances. One of a plurality of layers of the metallic material can be applied to edge.

### PRIORITY

This application claims the benefit and priority of U.S. Provisional Patent Application 61/177,088 filed May 11, 2009 in the name of inventors Roy, J. Bourcier, Victoria A. Edwards, Daniel W. Hawtof, Paul J. Shustack and Edward J. Fewkes, the Provisional Application being titled (A Method For Protecting A Glass Edge Using A Machinable Metal Armor.”

### FIELD

The invention is directed to a glass or glass-ceramic article having a composite material surrounding the edge of the glass or glass-ceramic to protect it from impact as well as providing a machinable material for final dimensional tolerance control.

### BACKGROUND

Glass and glass-ceramic parts are used as cover glasses in many consumer products; for example cell phones, laptop or notebook computers, electronic book readers, PDAs and other devices. The parts for such uses are frequently made by cutting a large glass sheet into the part's desired size and shape, and then finishing the part. Typically part of the finishing process for cut glass articles is grinding the edges to remove edge defects such as microcracks that may be present. While glass is a strong and tough material, its edges are susceptible to damage that can cause microcracks in the glass edge(s) to propagate. For example, when the glass part is used in a device, if the device should be dropped the shock imparted to the device would be transferred from the edges of the device to the glass part with the result that the microcracks propagate. If the shock force is great enough the glass part can crack. While various methods have been proposed for eliminating the microcracks or protecting the edges, none of these are satisfactory. For example, grinding the edges of the glass article is labor intensive, time consuming and expensive, and may not eliminate all the edge microcracks. Flame polishing the edges has been proposed, but this method is also relatively expensive, introduces internal stress and safety concerns, and may alter the final dimensions of the part. Coating the edge of the glass with polymeric materials has also been proposed, but this method requires capital outlays for the coating equipment, the introduction of complexity into the process of making the final part and may require strict environmental controls that introduces added costs. Thus, it is desirable to have a method that not only protects or “armors” the edge of glass parts, but also enable the armored part to be machined to final tolerances for use in a device.

### SUMMARY

The invention is directed to a shaped glass or glass-ceramic article having improved edge protection, said article comprising a glass or glass-ceramic article having one or a plurality of layers of a composite material surrounding the glass edge and protecting the glass edge from impact, as well as providing a machinable material for final dimensional tolerance control, said composite materials consisting of a metallic material (that is, a metallic tape or wire) of selected thickness bonded by an adhesive layer to the edges of the glass or glass ceramic article. In one embodiment one layer of metallic material is applied to the edge of the article. In another embodiment a plurality of layers of metallic material are applied to edge, the first layer being applied directly to the article's edge and the remainder of the plurality of layers being applied one on top of another around the edge. In a preferred embodiment the glass or glass ceramic article is transparent and is suitable for use as a cover glass or touch screen for electronic products such as cell phones, laptop computers, personal music players, book readers and similar devices.

In one embodiment the shaped glass or glass-ceramic article is selected from the group consisting of soda-lime, borosilicate, aluminoborosilicate, doped borosilicate, and doped aluminoborosilicate glass, and glass-ceramics derived from said glasses. The glass articles have a selected length and width, and a thickness in the range of 0.2 mm to 1.5 mm. In one embodiment the thickness is in the range of 0.7 mm. In another embodiment the thickness of the glass article is in the range of 0.2 to 0.5 mm. Glass ceramics are obtained by ceramming the glass composition using methods known in the art.

In another embodiment the shaped glass or glass-ceramic article is selected from the groups consisting of chemically strengthened borosilicate, chemically strengthened aluminoborosilicate, chemically strengthened doped borosilicate, chemically strengthen soda lime and chemically strengthened doped aluminoborosilicate glasses, and also glass-ceramics derived from said glasses. Chemical strengthening can be done by ion exchange in which smaller ions are exchanged for larger ions (for example without limitation, exchanging potassium ions for smaller sodium ions), ion implanting in which energetic ions are bombarded onto a glass surface and implanted into the surface of the glass, and other methods of chemically strengthening glass as is known in the art. In a further embodiment the glass or glass-ceramic can be a thermally tempered glass or glass laminate (see U.S. Pat. No. 7,514,149 for methods of making laminates). The glass articles have a selected length and width, and a thickness in the range of 0.2 mm to 1.5 mm. In one embodiment the thickness is in the range of 0.7 mm. In another embodiment the thickness of the glass article is in the range of 0.2 to 0.5 mm.

In a further embodiment the shaped glass article is a glass laminate can be formed by bonding glass layers together by heating two glass pieces or by bonding two glass (or two glass-ceramic, or one glass and one glass-ceramic) layers using lithium as is described in U.S. Patent Publication No. 2003/0188553. The glass and glass-ceramic layers can be made of any of the glass materials described herein. The laminate layers can be also be bonded together using a polymer interface or application of an adhesive between the layers.

In one embodiment the metallic tape or wire has a thickness in the range of 0.050-0.38 mm. In another embodiment the adhesive layer has a thickness in the range of 0.02 to 0.04 mm. In an additional embodiment the composite material is a metallic tape having a metal layer and an adhesive layer, said metallic layer has a thickness in the range of 0.050-0.38 mm and said adhesive layer has a thickness in the range of 0.02 to 0.04 mm. In a further embodiment the metallic material of the tape or wire is selected from the group consisting of aluminum or anodized aluminum, titanium or anodized titanium, nickel, copper and lead.

Also described herein is a method for armoring using the edge of a shaped glass or glass-ceramic article for use in small electronic devices by applying a composite material(s) to the glass edge to protect the edge from impact, as well as providing a machinable material for final dimensional tolerance control. The composite materials consist of a metallic tape or wire of selected thickness bonded by an adhesive layer to the edges of the glass or glass ceramic article. In an additional embodiment, when the edge of the glass article has a bezel, it is also desirable to minimize the presence of the bezel and maximize the size of the glass cover. It is desirable to have a method that produces a thin, decorative, consumer-pleasing finish for the edge.

On an embodiment the invention is directed to a method of making a shaped glass or glass-ceramic article by providing a shaped glass or glass ceramic article having a selected length and width, and a selected thickness defining the edge; providing a metallic material with or without an adhesive material applied to one side of the metallic material; providing an adhesive material when the provided metallic material does not have an adhesive material thereon and applying the adhesive material to the metallic material or to the edge of the article; and binding the metallic material to the edge with the adhesive material to form a shaped glass or glass-ceramic article have an edge armored by said bonded metallic material. One or a plurality of layers of the metallic material can be applied to the edge. When a plurality of layers are applied to the edge, the first layer is adhesively bonded to the glass edge and the remainder of the of the plurality of layers of metallic material are bonded to the first metallic material layer in a sequential manner, one on top of another.

Also described herein is a glass or glass-ceramic article having improved edge protection, said article comprising a shaped glass or glass-ceramic article having a composite material surrounding the glass edge and protecting the glass edge from impact, said composite material further well as providing a machinable material for final dimensional tolerance control, said composite material consisting of at least one layer of a metallic material of selected thickness bonded by an adhesive layer to the edges of the glass or glass-ceramic article; and

wherein said shaped glass article has a selected length and width, and a selected thickness.

### BRIEF DESCRIPTION OF THE DRAWINGS

FIG. 1 is a photograph of one test device used for drop-testing armored and unarmored glass edges.

FIG. 2 is an illustration of a glass part 18 just prior to impact on impacter 14.

FIG. 3 is a photograph of a glass part wrapped with 0.05 mm thickness of aluminum tape resting on top of the steel impacter after drop testing.

FIG. 4 is a photograph of a glass part 18 having one armored edge 20 on the right side and one unarmored edge 22 on the left side after subjecting the armored side to 5 drops from a 1 meter height and the unarmored side to a single 1 meter drop.

FIG. 5 is a xerographic copy of the article pictured in FIG. 4 showing the glass part 18, armored right side 20, unarmored left side 22, breaking point 26, and the crack 24 that extends from breaking point 26 across glass 8 to the upper right corner of the glass.

FIG. 6 is a bar chart showing the breaking height for armored and unarmored glass edges after dropping at various heights.

FIG. 7(a)-(c) is a diagram illustrating the placement of a metal tape on the edge of a glass article followed by trimming to produce an armored glass edge, a two-step process.

FIG. 8(a)-(b) is a diagram illustrating the placement of a metal wire on the edge of a glass article to produce an armored glass edge, a one-step process.

FIG. 9 is a simplified side view illustration of a sled apparatus for testing armored and unarmored glass articles.

FIG. 10 is a top vie of a glass article as it approached the impacter illustrated in FIG. 9.

FIG. 11 is an end view of a glass article having beveled edges.

FIG. 12 is a side view of a glass article having a rounded edge.

FIG. 13 is a chart illustrating the flexural strength of armored and unarmored glass articles after being edge impacted at different velocities.

FIG. 14 is the chart of FIG. 13 with added curves to illustrate the approximate increase in flexural strength after impact testing that is gained by armoring the edges of the glass.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements. The results in FIGS. 3-6 were obtained using a non-ion-exchanged alkali-aluminosilicate glass. The results in FIG. 14 were obtained using an ion-exchanged alkali-aluminosilicate glass.

As used herein the term “armored edge”, “armored” edge and similar terms means an edge having a selected metallic material of selected thickness around the edge, the material being held in place using an adhesive material to bond the metallic material to the edge of the glass or, when a plurality of layers of the selected materials are used, to bond a first layer to the glass and the remainder of the plurality of layers of the metallic material to one another. The terms “armoring material”, “armoring” material and similar terms means a combination of a selected metallic material and an adhesive material that is applied to the edge of a glass article, the adhesive material being used to bond the metallic material to the glass edge and to provide additional mechanical protection. The metallic material can be a flexible metallic tape or wire as defined herein, and unless otherwise distinguished in the specification or claims, the term “metallic material” means either a metallic tape or a metallic wire with or without adhesive.

Also as used herein the terms “tape,” “metallic tape,” and similar terms using the word “tape” means a flat or D-shaped, flexible metallic material having a width of greater than 0.25 inches (approximately 6.4 mm), and the terms “wire,” “metallic wire, “flat metallic wire,” “flat wire,” and similar terms, means a flat, flexible metallic material having a width of less than 0.25 inches (approximately 0.6 mm). The tape or wire can obtained commercially with or without an adhesive already placed on the tape. The adhesive material used to bond the tape or wire can be present on the tape or wire as-purchased. Alternatively, the metallic tape or wire can be purchased without adhesive and the adhesive applied to either (a) the edge(s) of the glass article, or (b) to the tape or wire to bond the tape or wire to the glass. In the examples herein tape or wire having an adhesive layer already applied to the tape or wire was purchased and used as obtained.

In one embodiment the adhesive material, tape or wire, can be applied to the glass edge and the metallic material is then applied to the adhesive material which bonds the adhesive material to the glass; that is, in a sequential manner. In an alternative embodiment the adhesive can be applied to the metallic material and the combination applied to the glass edge, the adhesive material bonding the metallic material to the glass edge. A metallic material having a metallic layer and an adhesive layer is an example of an armoring material that can be used in practicing the invention.

The invention is directed to a glass or glass-ceramic article having a composite material surrounding the glass edge and protecting the glass edge from impact, as well as providing a machinable material for final dimensional tolerance control. In the Examples herein an inexpensive commercially available metallic tape or wire was used to provide the armor layer to the glass edge. This armor layer is comprised of an adhesive layer and a metal layer. The metal layer used in the tests described herein is an aluminum layer. Similar results were obtained using a copper layer. The aluminum can have a thickness in the range of 0.002-0.015 inch (0.050-0.38 mm) thick. The adhesive layer has been a 0.001 inch (0.025 mm) pressure sensitive adhesive. Other metals that can be used as the metallic layer include, without limitation, copper, gold, silver, stainless steel, lea, titanium and nickel. The thickness of the metallic layer for these other metals is in the same range as that for aluminum. The metallic materials are commercially available from large number of suppliers. The aluminum tape used in the examples herein was purchased from All Foils, Inc., Strongsville, Ohio.

As indicated above, the armoring material described herein is a composite consisting of a metallic material and an adhesive used to bind the metallic material to the glass. The Young's modulus of elasticity “E” of the metallic and adhesive layers differ, with the adhesive layer having a lower modulus than the metallic layer. Generally the modulus E of the metallic material is in the range of 18 GPa (lead) to 193 GPa (stainless steel). Copper and copper alloys have a modulus E in the range of 110-138 GPa and Al and Al alloys have a modulus E of approximately 70 GPa. Polymer adhesives have a modulus E in the approximate range of a 0.8 GPa to 4.5 GPa. Some representative adhesive modulus values are epoxides=3.52, silicones=1.0. The adhesive can be any adhesive material capable of bonding the metal material (tape or wire) to the glass or glass -ceramic. Examples of such adhesive include, without limitation, epoxy, urethane, silicone, acrylic, hot-melt and photocurable adhesives. The adhesive thickness used to bond the metallic material to the article or another layer of metallic material can be in the range of 0.005 mm to 0.1 mm. In one embodiment the adhesive thickness is in the range of 0.02 mm to 0.04 mm.

Shaped glass and glass-ceramic compositions that can be armored include, without limitation, soda-lime, borosilicate, aluminoborosilicate, chalcogenide, doped borosilicate, doped aluminoborosilicate and other types of glass known in the art and glass-ceramics made from such glasses. The glass can be made my various methods known including, without limitation, the float, fusion or slot draw processes; and the glass can be formed into a non-flat shape by known methods, for example without limitation, by sagging or pressing. The article glass can also be rectangular, square oblong other shapes as desired. The glass can be clear or colored, transparent or opaque, and have optional properties including, without limitation, one or all of being polarizing, photochromic, anti-reflective and anti-glare. For use in small electronic equipment such as cell phones, personal music players, electronic book readers, laptop computers and similar devices transparent glass is preferred. In some embodiments the glass can be a chemically or thermally strengthened glass. In other embodiments the glass can be a laminated glass. Chemically strengthened glasses are those in which metal ions in the glass are chemically exchanged for larger metallic ions or in which metallic ions are implanted in the glass composition. Typically, glass is chemically strengthened by exchanging larger alkali ions for smaller alkali ion present in the original glass composition. For example, without limitation, most commonly by exchanging potassium ions for smaller sodium and/or lithium ions present in the original glass composition. Potassium ions in an original glass composition can also be replaced by larger ions through ion exchange.

In one embodiment, an armored glass article was made using a metallic tape having an adhesive coating on one side of the tape. The metal tape was wrapped around the peripheral edge of the glass and then trimmed to be flush with the glass surface; for example, by using a razor knife. The resulting piece is attractive—with a shiny metallic edge—and has far improved drop survival properties relative to a glass whose edge is not armored. The added advantage of the metal armor is to provide a machinable material (much easier than glass machining) to provide for the final part geometric specifications. If the tape is made from a metal suitable for anodization, for example, aluminum or titanium, the machined part can be anodized by methods known to produce a colored edge. In a further embodiment the metallic “tape” is supplied without the adhesive and the adhesive is placed on either the glass edge or the tape to bond the tape to the glass. FIGS. 7(a)-7(c) illustrate the steps of the process of applying and trimming the tape. FIG. 7(a) illustrates glass part 18 having an edge thickness 20 to which is adhesively applied a metallic tape 24 as illustrated in FIG. 7(b), the metallic tape 24 (heavy black border to accentuate the tape, the underlying grey rectangle representing the glass edge) being wider than the glass edge 20. After the metallic tape 24 has been adhesively applied to edge 20 is trimmed along dashed lines 27 to form glass part 18(a) whose edge 20 is armored by one or a plurality of metallic tape 24. One or a plurality of metallic tape layers 24 can be applied to edge 20. When a plurality of layers is applied the application can done by continuously wrapping the tape around the edge followed by trimming excess tape material or the plurality of layers can be applied and trimmed one-by-one. Continuous wrapping and a single trimming step is preferred. In FIG. 7(c) the edge 20 underlies the trimmed tape 24 and would not be visible through the tape. Any machining of the tape is preferably carried out using computer controlled equipment.

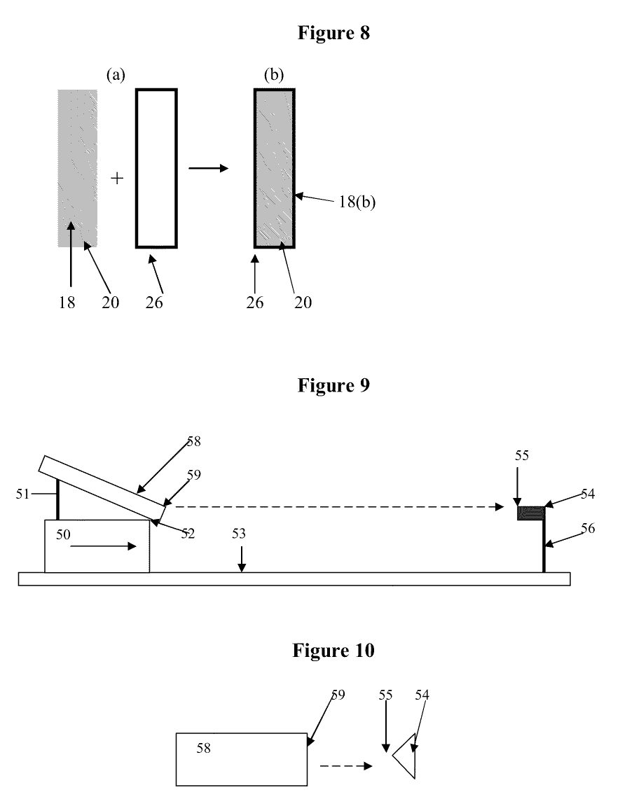

In another embodiment, an armored glass article was made using a metallic wire having an adhesive coating on one side of the tape. The metallic wire has a width equal to the width of the glass edge that is to be armored. The metal wire was wrapped around the peripheral edge of the glass. Because the metallic wire has a width equal to that of the glass edge no trimming is necessary. The resulting piece is attractive—with a shiny metallic edge—and has far improved drop survival properties relative to a glass whose edge is not armored. The added advantage of the metal armor is to provide a machinable material (much easier than glass machining) to provide for the final part geometric specifications. If the wire is made from a metal suitable for anodization, for example, aluminum or titanium, the machined part can be anodized to produce a colored edge. In a further embodiment the metallic “wire” is supplied without the adhesive and the adhesive is placed on either the glass edge or the tape to bond the wire to the glass. FIGS. 8(a)-8(b) illustrate the one-step process of adhesively applying a metallic wire to the edge 20 of a glass part 18. The metallic wire has a width equal to or less than that of glass edge 20. It is preferred that the width be equal to that of the edge, such that the entire edge width is fully protected from damage. FIG. 8(a) illustrates glass part 18 having an edge thickness 20 to which is adhesively applied a metallic wire 26 as illustrated in FIG. 8(b), the metallic wire 26 (heavy black border to accentuate the tape, the underlying grey rectangle representing the glass edge) has the same width as glass 18 edge 20. Consequently, no trimming of the wire is required since the wire has the same width as the as glass edge 20. Adhesively applying the metallic wire 26 to glass part 18 edge 20 forms the glass part 18(b) whose edge 20 is armored by one or a plurality of metallic wire layers 26. A plurality of metallic wire layers can be formed by continuously wrapping metallic wire 26 around edge 20 until the desired number of layers have been formed. In FIG. 8(b) the glass edge 20 underlies the metallic 26 and is not visible through the wire 26.

One advantage of the invention is that it provides a relatively inexpensive method of armoring a glass edge to prevent breakage and crack formation and/or propagation. Metal tapes and wires are an inexpensive commodity and the process of applying a metallic tape or wire to a glass edge that may have microcracks is far cheaper than the grinding and polishing process that is used on glass parts remove microcracks and other edge defects. Alternatively, if deemed desirable to further improve edge strength, or to make parts having the better damage resistance then parts that have only been ground and polished, one could armor a ground/polished edge to achieve significantly better damage resistance at only a marginally higher cost. Thus, one can tailor the edge-preparation and edge-protection steps in this invention to optimize cost and performance. Additionally, some metals, for example, aluminum or titanium, can be anodized to achieve different decorative colors that are well-adhered to the underlying protective metal. Thus, a variety of metal types (different hardness, composition, modulus, metal or anodized colors, thickness) can be used in practicing the invention. The same is true for the adhesives (hardness, thickness, cure mechanism).

In the examples of FIGS. 3-6 a non-ion-exchanged fusion drawn glass was used as the exemplary glass. The glass samples had a length and width of 100 mm and 60 mm, respectively. The glass thickness was 0.7 mm and the edges were armored by wrapping them using a standard aluminum metal tape (thickness of 0.05 mm adhesive plus aluminum metal, available from All Foil, Inc.) in 2-7 wraps or layers around the glass part. After the tape was applied it was trimmed. Additional tests were performed using a simple 0.05 mm Al metal layer with a 3M pressure sensitive adhesive.

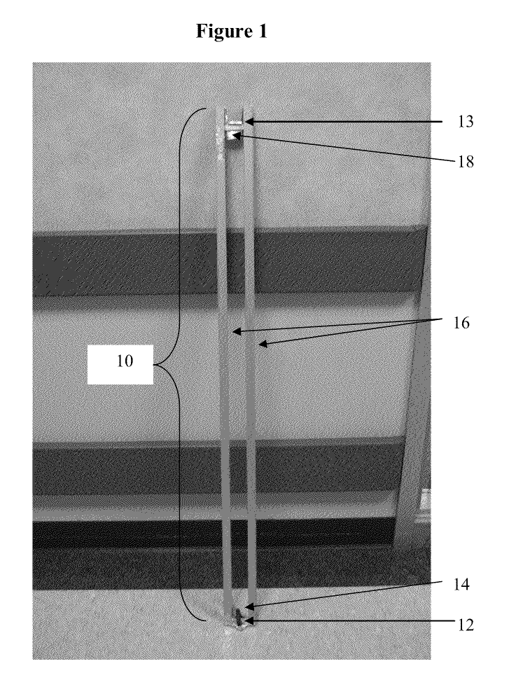

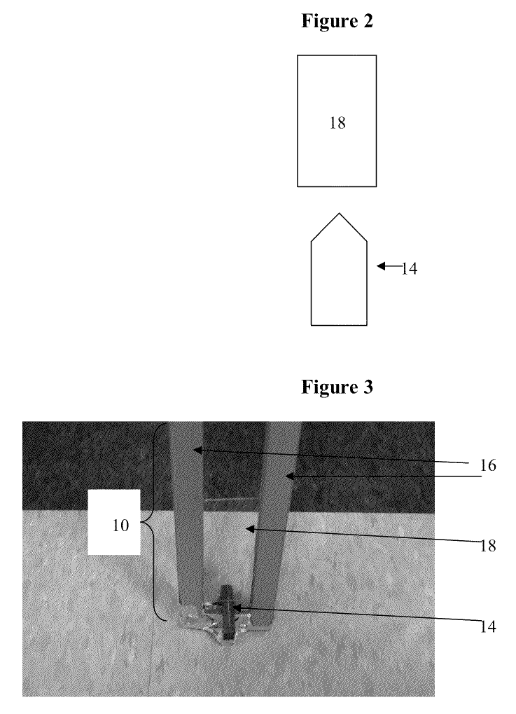

FIG. 1 illustrates a simple drop-test device 10 that was used to test the glass parts (the un-numbered background being the wall and floor of the laboratory). The device has two slotted uprights 16, in which the slots face one another, joined by top 13 and bottom 12 fasteners. Positioned on bottom fastener 12 is a steel impacter 14. Top fastener 13 is movable along the slots of uprights 16 so that glass 18 can be dropped from different heights. Top fastener 1 also has an opening, port or slot so that glass 18 can be positioned for dropping onto impacter 14. Also shown in FIG. 1 is how the glass article 18 is positioned for dropping onto impacter 14. The glass article is sized to fit into the upright slots, without being held in the slots by friction, for dropping onto impacter 14. The glass part 18 is hand positioned in the slot at a selected height and then released. The device shown in FIG. 1 has a one (1) meter drop length. A second device having the same design and a two (2) meter drop length (not illustrated) was also used in the testing. FIG. 2 illustrates a glass part 18 just before impact with impacter 14. FIG. 3 illustrates a portion of the device 10 and shows glass part 18 after it was dropped onto impacter 18. FIG. 3 shows that after dropping, glass part 18 is in the slots of uprights 16 and is in contact with impacter 14.

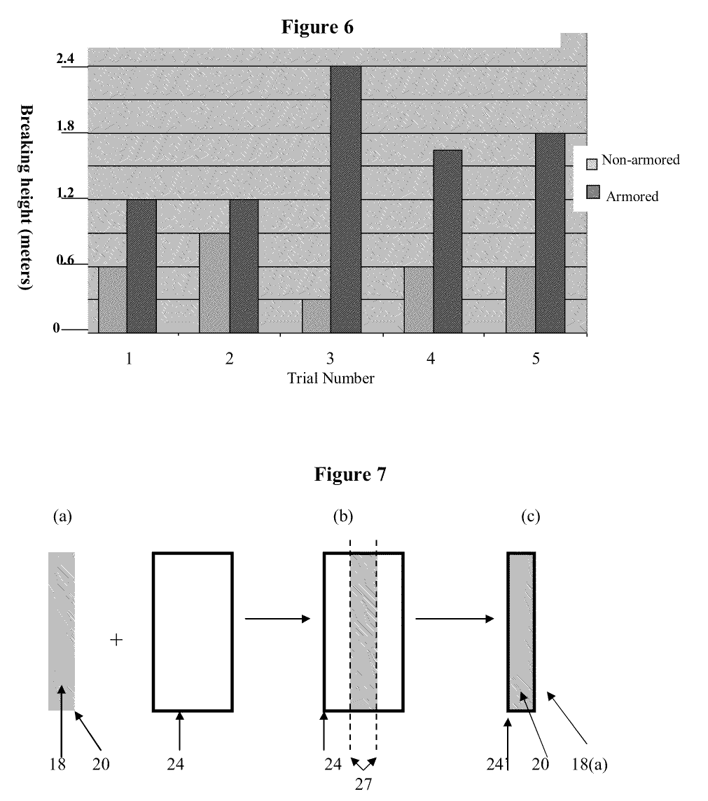

Tables 1 and 2 show the test results for samples of both non-armored (Table 1) and “armored” (Table 2) non-chemically strengthen glass. The non-armored and “armored” glasses were dropped from various heights onto a steel impacter blade. Five sample of armored and non-armored glass were tested. The drop test results are summarized in FIG. 6. The results indicate that in each case armoring the glass edge protects it from damage when dropped.

TABLE 1
Non-armored Glass

| Sample No. | Height (m) |
|---|---|
| S1 | 0.6 |
| S2 | 0.9 |
| S3 | 0.3 |
| S4 | 0.6 |
| S5 | 0.6 |
| Avg. Hgt. | 0.6 |
| Smallest Hgt. | 0.3 |
| Greatest Hgt. | 0.9 |

TABLE 2
Armored Glass

| Sample No. | Height (m) |
|---|---|
| E1 | 1.2 |
| E2 | 1.2 |
| E3 | 2.4 |
| E4 | 1.65 |
| E5 | 1.8 |
| Avg. Hgt. | 1.65 |
| Smallest Hgt. | 1.2 |
| Greatest Hgt. | 2.4 |

Non-armored = non-ion-exchanged alkali-aluminosilicate glass with unarmored edges
Armored = non-ion-exchanged glass with armored edges
m = meters

The results show that in 80% of the tests the unarmored glass is broken by the impacter blade when the glass is dropped from a height of 0.6 m or less. In contrast to the unarmored glass, all armored samples survived dropping from a height of 1.2 m, and 60% of the samples survived dropping from a height ≧1.6 m.

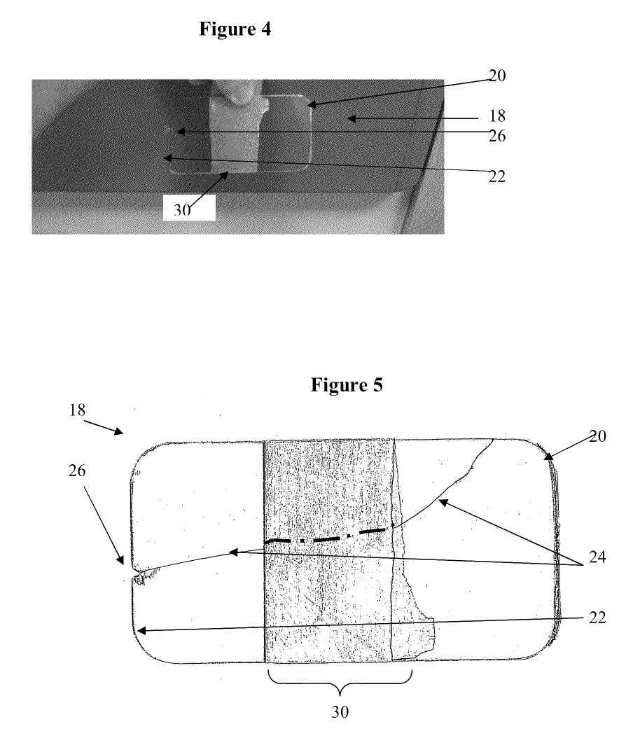

FIG. 4 is a photograph of a glass part 18 having one armored edge 20 on the right side and one unarmored edge 22 on the left side. The glass 18 was first dropped five (5) times on the armored edge, and it survived all the drops without any cracking. The glass 18 was then dropped once on the unarmored side; it cracked at the point indicated by arrow 26; and it broke into two pieces (which in FIG. 4 are held together by tape 30). FIG. 5 is a xerographic copy of the article pictured in FIG. 4 showing the glass part 18, armored right side 20, unarmored left side 22, breaking point 26, and the crack 24 that extends from breaking point 26 across glass 8 to the upper right of the glass. Arrow 30 indicates the tape that holds the two glass pieces together. FIGS. 4 and 5 thus illustrate that armoring glass edges as described herein greatly increases its ability to survive edge drops.

The application of a plurality of metallic tape or wire layers to the edge of a glass part not only protects the part against the development of cracks if the device in which the glass part is used is accidentally dropped, but it also enables machining of the edge to a final tolerance suitable for the intended use. For example, if the part is required to have facial dimensions x and y and it is found that the holder for the part is slightly smaller than specifications, metallic edge armor can be machined to fit the smaller holder. This avoids having to reject parts and increases the production yield.

The drop test apparatus illustrated in FIG. 1 was found to be inadequate for testing chemically strengthened (ion exchanged) glass. When a 2-meter drop test device was used erratic results were produced for the unarmored glass, some samples breaking at 2-meters and some not breaking. None of the armored chemically strengthened glass samples broke at 2-meters. In order to enable testing armored samples of chemically strengthened glass to their breaking point an “Impact Test” (“IT”) apparatus as illustrated in FIG. 9 was made. The apparatus has of a sled 50 mounted on a track 53 and an upright 56 having an impacter 54 with edge 55 attached to upright 56. The sled 50 has an upright 52 for attaching glass article 58 (armored or unarmored) at an angle such that the forward edge 59 of the glass 58 overhangs the forward edge 52 of sled 50. The apparatus also has a drive mechanism and controller (not illustrated) for propelling the sled 50 with attached glass sample 58 forward at a selected velocity such that the edge 59 of glass 58 strikes the edge 55 of impacter 54. The velocity at which the sled is propelled toward the impacter is adjustable by using the controller. FIG. 10 is a top view of glass 58 being propelled forward (dashed arrow) just before glass 58 edge 59 strikes the edge 55 of impacter 54.

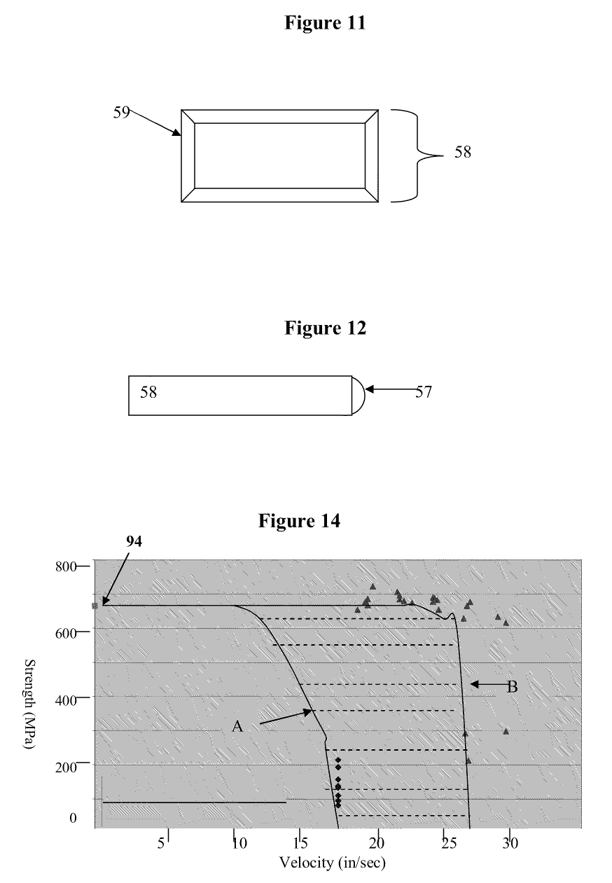

The apparatus illustrated in FIG. 9 was used to test samples of commercially available chemically strengthened glass (Gorilla™ Glass (“GG”), Corning Incorporated) both armored and unarmored. The glass samples had a length and width of 60 mm and 45 mm, respectively. The glass thickness was 0.7 mm and the edges were armored by wrapping them using a standard aluminum metal tape as has been described above. The glass samples were prepared by scribing and breaking (known in the art) larger pieces of glass. After scribing and breaking the peripheral edges of the glass were ground and polished to smooth and remove any microcracks present on the surface. The edges were also either beveled as illustrated in FIG. 11 or rounded as illustrated in FIG. 12.

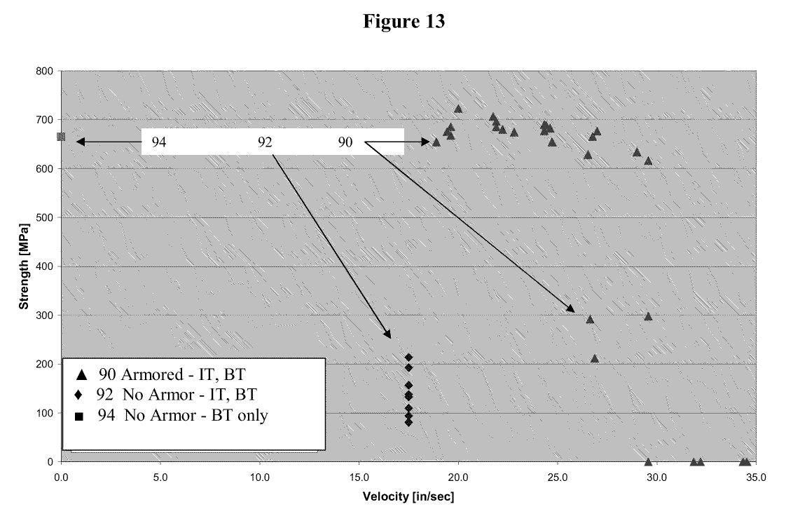

The test method used to evaluate armored and unarmored glass samples is a two-step test method. The first step is impact test the samples by mounting the glass sample (armored or unarmored) on sled 50 and propel it to strike edge 55 of impacter 54. If the sample does not break of develop and cracks in the impact test it is then subjected to a 4-point bend test to measure flexural strength of the sample after the sled test. The bend test was carried out using a commercially available instrument such as an Instron 5565 (Instron, Inc. Norwood, Mass.). FIG. 13 summarizes the test results. The square block (▪) 94 represents a GG sample that was not impact tested but was bend tested. The flexural strength of the glass is approximately 670 MPa. Unarmored GG glass samples represented by diamond (♦) 92 were first impact tested at a velocity of approximately 17 inches/second (in/sec), or approximately 43 cm/sec, and then subjected to the bend test. The samples exhibit a flexural strength ranging from approximately 190 MPa to approximately 210 MPa for all eight samples tested. The armored GG samples were impact tested at velocities ranging from 20 in/sec (approximately 51 cm/sec) to 35 in/sec (approximately 89 cm/sec). Up to an impact velocity of approximately 25 in/sec all the glass samples showed a flexural strength in the range of 600-700 MPa indicating that the armored samples retain the flexural strength of the non-impacted sample represented by numeral 94. At an impact velocity of approximately 27.5 in/sec three glass samples retained flexural strength in the range of 600-700 MPa and two samples showed a reduced flexural strength in the range of 200-300 MPa. At an impact velocity of 30 in/sec, two samples retained a flexural strength in the range of 600-700 MPa, one sample has a flexural strength of ˜300 MPa and one sample has a flexural strength of zero MPa. The data for samples impacted at velocities in the range of 27.5-30 in/sec indicates that whether or not a sample survives bend testing may be partially dependent on the armoring material being properly applied. At impact velocities greater than 30 in/sec all four samples failed the bend test and all showed a flexural strength of zero MPa. These samples all broke when the glass impacted the edge 55 illustrated in FIGS. 9 and 10. FIG. 14 is the same as FIG. 13 with the addition of lines A and B and the dashed lines connecting them. The distance between lines A and A represents the approximate increase in impact damage resistance that is gained by armoring the edges of the glass.

It will be apparent to those skilled in the art that various modifications and variations can be made to the present disclosure without departing from the spirit and scope of the invention. Thus, it is intended that the present invention cover the modifications and variations of this disclosure provided they come within the scope of the appended claims and their equivalents.

We claim:

1. A glass or glass-ceramic article having improved edge protection, said article comprising a shaped glass or glass-ceramic article having a composite material surrounding the glass edge and protecting the glass edge from impact, said composite material further well as providing a machinable material for final dimensional tolerance control, said composite material consisting of at least one layer of a metallic material of selected thickness bonded by an adhesive layer to the edges of the glass or glass-ceramic article; and
wherein said shaped glass article has a selected length and width, and a selected thickness.

2. The article according to claim 1, wherein the article has a selected thickness in the range of 0.2 mm to 1.5 mm.

3. The article according to claim 1, wherein the article has a selected thickness is in the range of 0.2 mm to 0.7 mm.

4. The article according to claim 1, wherein the article has a selected thickness is in the range of 0.3 mm to 0.5 mm.

5. The article according to claim 1, wherein the glass is selected from the group consisting of soda lime, borosilicate, aluminoborosilicate, doped borosilicate, and doped aluminoborosilicate glass.

6. The article according to claim 1, wherein the glass-ceramic is selected from the group consisting of a cerammed soda lime, borosilicate, aluminoborosilicate, doped borosilicate, and doped aluminoborosilicate glass having crystalline particles dispersed within an amorphous glass matrix.

7. The article according to claim 1, wherein the glass is selected from the groups consisting of chemically strengthened borosilicate, chemically strengthened aluminoborosilicate, chemically strengthened doped borosilicate, chemically strengthened soda lime, and chemically strengthened doped aluminoborosilicate glass.

8. The article according to claim 1, wherein said at least one metallic material has a thickness in the range of 0.050-0.38 mm.

9. The article according to claim 1, wherein the adhesive layer has a thickness in the range of 0.005 to 0.1 mm.

10. The article according to claim 1, wherein said composite material is selected from the group consisting of:
(a) a metallic tape consisting of a metal layer with an adhesive layer on one side of the metal layer, said metal layer has a thickness in the range of 0.050-0.38 mm and said adhesive layer has a thickness in the range of 0.02 to 0.04 mm; and
(b) a metallic wire consisting of a metal layer with an adhesive layer on one side of the metal layer, said metal layer has a thickness in the range of 0.050-0.38 mm and said adhesive layer has a thickness in the range of 0.02 to 0.04 mm.

11. The article according to claim 1, wherein the metal of said metallic material is selected from the group consisting of aluminum, anodized aluminum, titanium, anodized titanium, nickel and copper.

12. The article according to claim 1, wherein the metal of the metallic layer has a Young's modulus in the range of 18-193 GPa.

13. The article according to claim 1, wherein the adhesive has a young's modulus in the approximate range of range of approximately 0.8-4.5 GPa.

14. A method for protecting the edges of a shaped glass or glass-ceramic article, said method comprising:
providing a shaped glass or glass ceramic article having a selected length and width, and a selected thickness in the range of 0.2 mm to 1.5 mm defining the edge of the article;
providing a metallic material with or without an adhesive material applied to one side of the metallic material;
providing an adhesive material when the provided metallic material does not have an adhesive material thereon and applying the adhesive material to the metallic material or to the edge of the article;
binding the metallic material to the edge with the adhesive material to form a shaped glass or glass-ceramic article have an edge armored by said bonded metallic material.

15. The method according to claim 14, wherein a plurality of layers of the metallic material are applied to the edge, the first layer being adhesively bonded to the glass edge and the remainder of the plurality of layers of metallic material being bonded to the first metallic material layer in a sequential manner, one on top of another.

16. The method according to claim 14, wherein said metallic material is a metallic material is selected from the group consisting of metallic tapes and wires, and the metal of said metallic material is selected from the group consisting of aluminum, anodized aluminum, titanium, anodized titanium, nickel, and copper.

17. The method according to claim 14, wherein the provided adhesive is selected from the group consisting of epoxy, urethane, silicone, acrylic, hot-melt and photocurable adhesives.
